(19) United States
(12) Patent Application Publication
(10) Pub. No.: US 2025/0265953 A1
(43) Pub. Date: Aug. 21, 2025

(54) DISPLAY PANEL AND PIXEL CIRCUIT THEREOF

(71) Applicant: Powerchip Micro Device Corporation, Hsinchu (TW)

(72) Inventors: Chen Chi Lin, Hsinchu (TW); Jih Fon Huang, Hsinchu (TW)

(73) Assignee: Powerchip Micro Device Corporation, Hsinchu (TW)

(21) Appl. No.: 18/916,721

(22) Filed: Oct. 16, 2024

(30) Foreign Application Priority Data
Feb. 21, 2024 (TW) 113106116

(51) Int. Cl. G09G 3/00; G09G 3/32; G09G 3/3233

(52) U.S. Cl. CPC G09G 3/006; G09G 3/3233; G09G 3/32; G09G 2300/0465; G09G 2300/0852; G09G 2310/08

(57) ABSTRACT

A display panel and a pixel circuit are provided. The pixel circuit includes a driving circuit and a first switch. The driving circuit is configured to couple to a light emitting component. The driving circuit receives write-in data and generates a driving current on a driving end according to the write-in data to drive the light emitting component. The first switch is coupled between the driving end and an external end and controlled by a control signal.

### CROSS-REFERENCE TO RELATED APPLICATION

This application claims the priority benefit of Taiwan application serial no. 113106116, filed on Feb. 21, 2024. The entirety of the above-mentioned patent application is hereby incorporated by reference herein and made a part of this specification.

### BACKGROUND

### Technical Field

The disclosure relates to a display panel and a pixel circuit thereof, and in particular relates to a display panel and a pixel circuit thereof that can improve resolution.

### Description of Related Art

With the advancement of electronic technology, people have increasingly higher demands for the performance of display devices in electronic products. Taking display devices used in head-mounted displays as an example, high-resolution display quality has become an important demand for people today.

However, in order to improve display quality, taking a light emitting diode display device as an example, the pixel circuit in a display device nowadays requires multiple transistors, multiple capacitors and multiple signal lines. Under such conditions, the size of the pixel circuit will be increased, and the number of pixel circuits that can be laid out on a fixed-area display panel will be limited. As a result, the resolution of the display panel cannot be effectively improved.

### SUMMARY

A display panel and a pixel circuit thereof, which can improve display resolution, are provided in the disclosure.

The pixel circuit of the disclosure includes a driving circuit and a first switch. The driving circuit is configured to couple to a light emitting component. The driving circuit receives write-in data and generates a driving current on a driving end according to the write-in data to drive the light emitting component. The first switch is coupled between the driving end and an external end and controlled by a control signal.

The display panel of the disclosure includes multiple pixel circuits as described above. The pixel circuits are arranged into a display array.

Based on the above, the pixel circuit of the disclosure can effectively reduce the circuit area by sharing or reducing circuit components and signal lines, thereby improving the resolution of the display panel. In addition, in response to the mass production requirements of the product, the pixel circuit of the disclosure effectively provides an internal test path for the driving circuit by setting up a first switch, so that the internal signal of the driving circuit can be read out through the first switch, thereby improving the yield rate of the manufactured products.

### BRIEF DESCRIPTION OF THE DRAWINGS

FIG. 1 is a schematic diagram of a pixel circuit of an embodiment of the disclosure.

FIG. 2 is a circuit schematic diagram of a pixel circuit of another embodiment of the disclosure.

FIG. 3A is a circuit schematic diagram of a pixel circuit in a test mode of an embodiment of the disclosure.

FIG. 3B is a waveform diagram of the test operation of the pixel circuit.

FIG. 4A is a circuit schematic diagram of a pixel circuit in a normal operating mode of an embodiment of the disclosure.

FIG. 4B is a waveform diagram of the normal operation of the pixel circuit.

FIG. 5 is a schematic diagram of a pixel circuit of another embodiment of the disclosure.

FIG. 6 is a schematic diagram of a pixel circuit of another embodiment of the disclosure.

FIG. 7 is a schematic diagram of a display panel of an embodiment of the disclosure.

FIG. 8 is a schematic diagram of a display panel of an embodiment of the disclosure.

FIG. 9 is a schematic diagram of a display panel of an embodiment of the disclosure.

### DETAILED DESCRIPTION OF DISCLOSED EMBODIMENTS

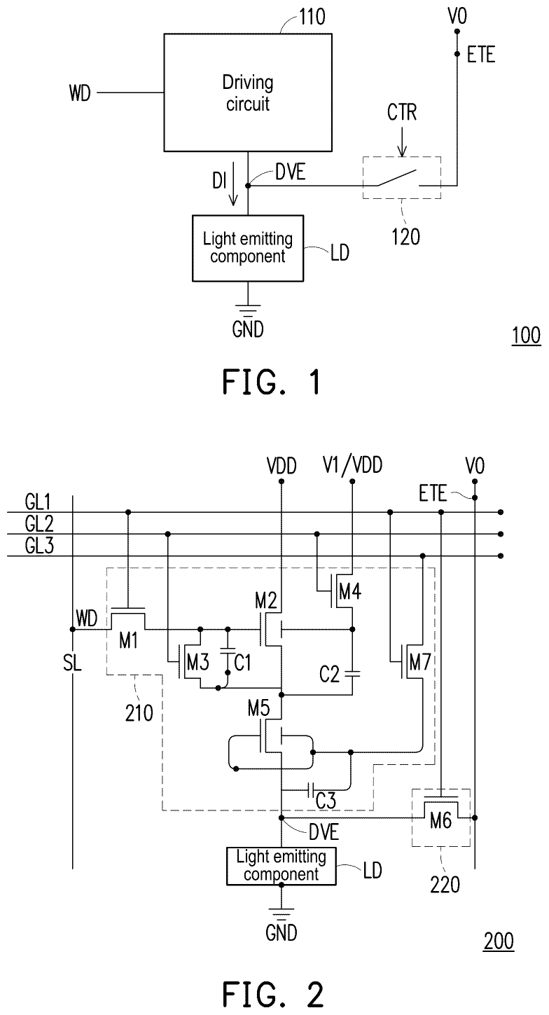

Referring to FIG. 1, FIG. 1 is a schematic diagram of a pixel circuit of an embodiment of the disclosure. The pixel circuit 100 includes a driving circuit 110 and a switch 120. The driving circuit 110 is configured to couple to a light emitting component LD. The driving circuit 110 receives the write-in data WD. The driving circuit 110 generates a driving current DI at the driving end DVE according to the write-in data WD to drive the light emitting component LD. The switch 120 is coupled between the driving end DVE and the external end ETE. The switch 120 is controlled by the control signal CTR to be turned on or off.

In this embodiment, the light emitting component LD may be a light emitting diode (LED) or an organic light emitting diode (OLED). The anode of the light emitting component LD can be coupled to the driving end DVE, and the cathode of the light emitting component LD can be coupled to the reference ground end GND.

In operation details, the switch 120 may be turned on according to the control signal CTR. When the switch 120 is turned on, the signal on the driving end DVE may be a test signal, which is transmitted to the external end ETE through the switch 120. On the other hand, when the switch 120 is turned on, the setting signal V0 on the external end ETE can also be transmitted to the driving end DVE through the switch 120.

To further explain, when the light emitting component LD is not connected to the driving end DVE on the driving circuit 110, in the test mode, the test can be executed on the pixel circuit 100. At this time, the switch 120 may be turned on according to the control signal CTR. The driving current DI on the driving end DVE of the driving circuit 110 can be transmitted to the external end ETE through the switch 120. In this way, the tester can obtain the driving current DI through the external end ETE, and know whether the driving circuit 110 can operate normally according to the magnitude of the driving current DI.

In the process of mass production manufacturing, the above-mentioned test mode can be executed in a state where the light emitting component LD has not been formed by deposition and coupled to the driving end DVE.

Next, after the light emitting component LD is set in the pixel circuit 100 and coupled to the driving end DVE, in the normal operating mode, the setting signal V0 on the external end ETE can also be transmitted to the driving end DVE through the switch 120, and the voltage on the anode end of the light emitting component LD can be set (or reset).

It is worth mentioning that in this embodiment, the pixel circuit 100 may be provided with a bonding pad on the external end ETE. Through this pad, in the test mode, the driving current DI generated by the driving circuit 110 can be read, and thereby the test operation of the driving circuit 110 can be executed. In the normal operating mode, the setting signal V0 can be transmitted to the driving end DVE through the bonding pad, thereby lighting the light emitting component LD.

It is easy to know from the above description that in the pixel circuit of the embodiment of the disclosure, by setting the switch 120 in conjunction with the mass production process of the display panel, the driving circuit 110 of the pixel circuit 100 in the display panel can be tested before the light emitting component LD is set. After the light emitting component LD is set, a suitable setting signal V0 can be provided to the driving circuit 110 to maintain the normal operation of the pixel circuit 100.

Referring to FIG. 2, FIG. 2 is a circuit schematic diagram of a pixel circuit of another embodiment of the disclosure. The pixel circuit 200 includes a driving circuit 210 and a switch 220. In this embodiment, the driving circuit 210 includes transistors M1 to M5 and M7 and capacitors C1 to C3. The switch 220 is formed of the transistor M6. In terms of circuit details, transistors M1, M3 to M7 are respectively configured to form multiple switches. The first end of the transistor M1 is coupled to the source line SL to receive the write-in data WD; the second end of the transistor M1 is coupled to the control end of the transistor M2; the control end of the transistor M1 is coupled to a gate line to receive a gate signal GL1. The transistor M2 is a driving transistor. The first end of the transistor M2 receives the power supply voltage VDD; the second end of the transistor M2 is coupled to the first end of the transistor M5. Furthermore, the capacitor C1 is coupled between the control end and the second end of the transistor M2. In addition, the first end and the second end of the transistor M3 are respectively coupled to two ends of the capacitor C1, and the control end of the transistor M3 is coupled to another gate line to receive a gate signal GL2.

In addition, the second end of the transistor M5 is coupled to the driving end DVE. The transistor M5 has a back gate, in which the gate and the back gate of the transistor M5 are coupled to each other. The capacitor C3 is coupled between the back gate of the transistor M5 and its second end.

The first end of the transistor M4 receives the reference voltage V1 or the power supply voltage VDD; the control end of the transistor M4 receives the gate signal GL2; the second end of the transistor M4 is coupled to the back gate of the transistor M2. In addition, the capacitor C2 is coupled between the second end of the transistor M4 and the second end of the transistor M2.

The first end of the transistor M7 is coupled to a gate line to receive the gate signal GL3; the control end of the transistor M7 receives the gate signal GL1; the second end of the transistor M7 is coupled to the back gate of the transistor M5, and coupled to the capacitor C3.

On the other hand, the transistor M6 is coupled between the driving end DVE and the external end ETE, and can be controlled by the gate signal GL1. The light emitting component LD can be coupled between the driving end DVE and the reference ground end GND.

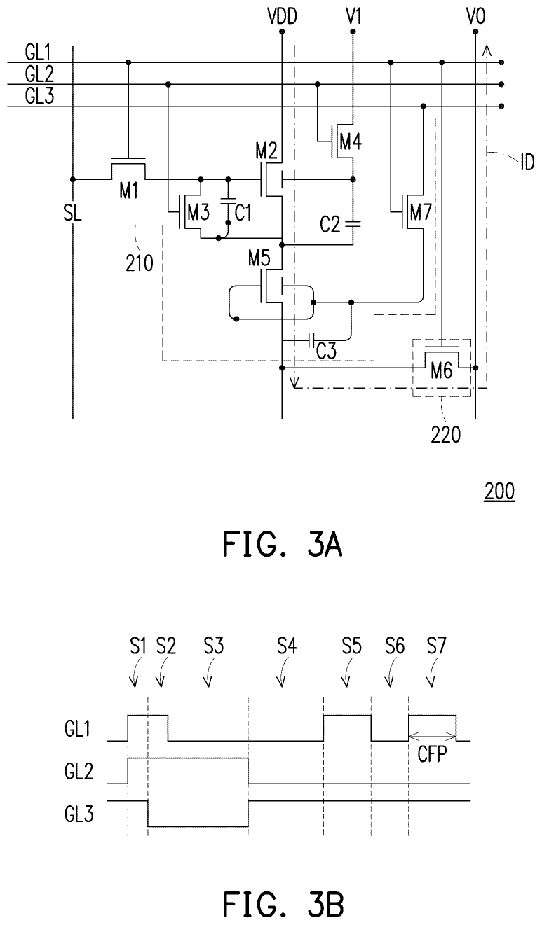

Regarding the operation details of the pixel circuit 200, please refer to FIG. 3A and FIG. 3B. FIG. 3A is a circuit schematic diagram of a pixel circuit in a test mode of an embodiment of the disclosure, and FIG. 3B is a waveform diagram of the test operation of the pixel circuit. In FIG. 3A, the pixel circuit 200 has a circuit architecture similar to that of FIG. 2, and the details are not repeated herein. It is worth noting that in FIG. 3A, the light emitting component LD has not yet been set in the pixel circuit 200.

In FIG. 3B, in stage S1, all gate signals GL1 to GL3 may be logic high voltages, and at this time, transistors M1, M3, M4, M7, and M6 may be turned on. At the same time, the turned-on transistor M7 can cause the gate end and the back gate of the transistor M5 to receive a logic high voltage and be turned on accordingly.

Next, in stage S2, the gate signal GL3 is pulled down to a logic low voltage, and the gate signals GL1 and GL2 are maintained at a logic high voltage. At this time, the pixel circuit 200 can execute the correction operation of the threshold voltage of the transistor M2. At this time, the transistors M3, M4, M6, and M7 are all in a conductive state, and the corresponding transistor M7 is in a conductive state. The control end of the transistor M5 can receive the gate signal GL3, which is equal to a logic low voltage. In this way, the transistor M5 can be in an off state. In addition, during this stage, the source line SL can remain in a floating state.

In stage S3, the gate signal GL1 is pulled down to a logic low voltage, and the gate signals GL2 and GL3 are respectively maintained at a logic high voltage and a logic low voltage. At this time, the transistors M1, M6, and M7 are in an off state. Corresponding to the turned-off transistor M7, the control end of the transistor M5 can be in a floating state, and the voltage on the control end of the transistor M5 remains unchanged. Therefore, the transistor M5 remains in the off state.

In addition, at this time, the transistor M4 can transmit the reference voltage V1 to the back gate of the transistor M2 and the first end of the capacitor C2, and turn on the transistor M2. At this time, the voltage on the control end of the transistor M2 may be equal to the reference voltage V1 minus the threshold voltage of the transistor M2. Since the transistor M3 is turned on, the voltages on both ends of the capacitor C1 are equal.

In stage S4, the gate signal GL2 is pulled down to a logic low voltage, the gate signal GL3 is pulled up to a logic high voltage, and the gate signal GL1 is maintained at a logic low voltage. At this time, transistors M3 and M4 are in an off state, the control end, back gate, and second end of transistor M2 are all in a floating state, and the voltages on these ends can remain unchanged. In addition, the transistor M5 remains in the off state.

In stage S5, the gate signal GL1 changes to a logic high voltage, the gate signal GL2 maintains at a logic low voltage, and the gate signal GL3 maintains at a logic high voltage. At this time, the transistor M1 is turned on, receives the write-in data WD transmitted on the source line SL, and causes the write-in data WD to be transmitted to the control end of the transistor M2. At the same time, the transistor M7 is turned on. The transistor M7 transmits the gate signal GL3 at a logic high voltage to the control end of the transistor M5, so that the transistor M5 is turned on.

In addition, the transistor M6 can be turned on at this time, and the set voltage V0 can be written to the driving end DVE. Through the turned-on transistor M5, the set voltage V0 can be transmitted to the second end of the transistor M2. At this time, the voltage on the first end of the capacitor C1 can be the write-in data WD, and the voltage on the second end of the capacitor C1 can be the set voltage V0; the voltage on the first end of the capacitor C2 may be the set voltage V0 plus the threshold voltage of the transistor M2, and the voltage on the second end of the capacitor C1 may be the set voltage V0.

In stage S6, the gate signal GL1 changes to a logic low voltage, the gate signal GL2 maintains at a logic low voltage, and the gate signal GL3 maintains at a logic high voltage. At this time, the transistors M1, M6, and M7 are changed to be cut off. The transistors M2 and M5 are in a conductive state.

Then, in stage S7, the gate signal GL1 changes to a logic high voltage, the gate signal GL2 maintains at a logic low voltage, and the gate signal GL3 maintains at a logic high voltage. At this time, the transistor M6 is correspondingly turned on. The transistor M2 can generate the driving current ID to the driving end DVE according to the voltage on the control end of the transistor M2. Moreover, during the current output period CFP, the driving current ID can flow through the switch 220 to the driving end DVE, thereby generating a test signal.

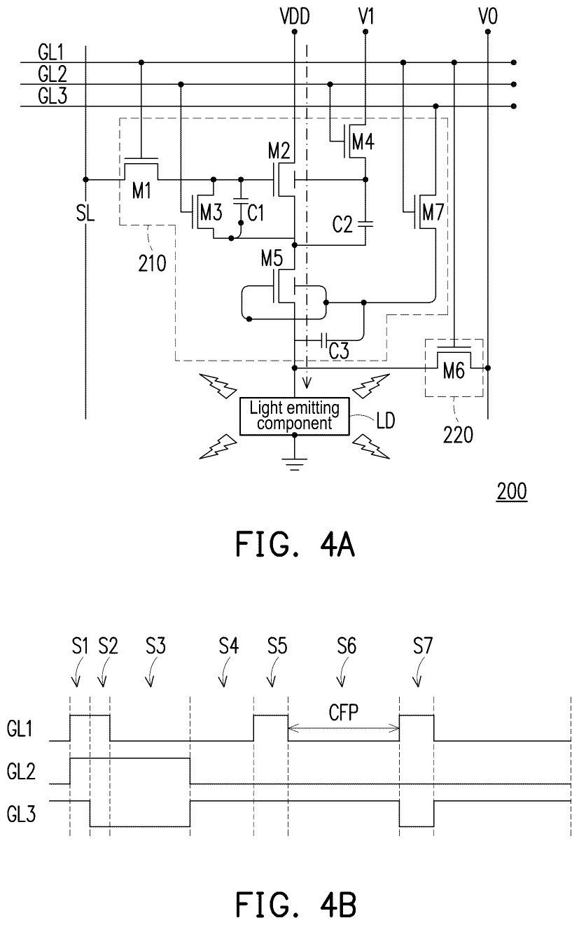

Further, reference may be made to FIG. 4A and FIG. 4B. FIG. 4A is a circuit schematic diagram of a pixel circuit in a normal operating mode of an embodiment of the disclosure, and FIG. 4B is a waveform diagram of the normal operation of the pixel circuit. In FIG. 4A, the pixel circuit 200 has a circuit architecture similar to that of FIG. 2, and the details are not repeated herein. It is worth noting that in FIG. 4A, the light emitting component LD has been set in the pixel circuit 200 and coupled to the driving end DVE.

In FIG. 4B, in stages S1 to S6, the waveforms of the gate signals GL1 to GL3 and the operation details of the pixel circuit 200 are similar to the embodiment of FIG. 3B, and are not repeated herein. It is worth mentioning that in stage S6, based on FIG. 4A, the light emitting component LD is coupled between the driving end DVE and the reference ground end GND, and a current loop can be formed. Therefore, at this time, the transistor M2 can generate the driving current ID according to the voltage on its control end during the current output period CFP, and cause the driving current ID to flow through the light emitting component LD, so that the light emitting component LD is lit.

It is worth mentioning that in this embodiment, in stage S6, the transistor M6 is turned off. Therefore, the switch 220 does not cause a shunt phenomenon to the light emitting component LD and affect the light emitting brightness of the light emitting component LD.

In addition, in the stage S7, the gate signals GL1 to GL3 are respectively logic high voltage, logic low voltage, and logic low voltage. By setting the gate signal GL1 to a logic high voltage and the gate signal GL3 to a logic low voltage, the transistor M7 can be turned on and the voltage on the control end and back gate of the transistor M5 can be at a logic low voltage. In this way, the transistor M5 can be turned off, causing the light emitting component LD to stop emitting light.

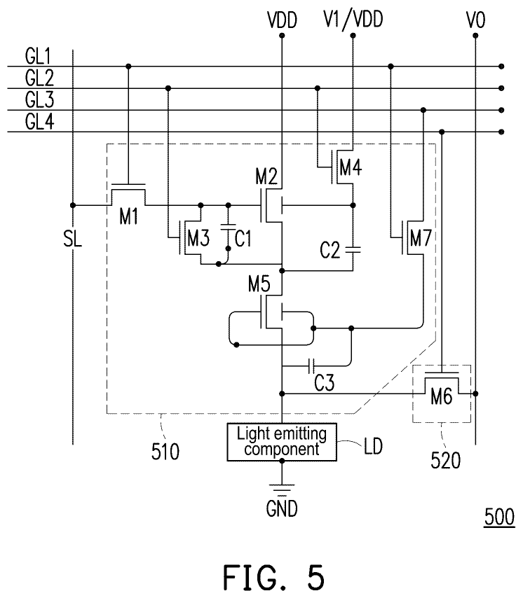

Referring to FIG. 5 below, FIG. 5 is a schematic diagram of a pixel circuit of another embodiment of the disclosure. The pixel circuit 500 includes a driving circuit 510 and a switch 520. In this embodiment, the driving circuit 510 includes transistors M1 to M5 and M7 and capacitors C1 to C3. The switch 520 is formed of the transistor M6. The driving circuit 510 is coupled to the light emitting component LD through the driving end DVE.

The circuit architecture of the driving circuit 510 of this embodiment is generally similar to the driving circuit 210 of the embodiment of FIG. 2, and the same parts are not repeated herein. The difference between the driving circuit 510 in this embodiment and the driving circuit 210 is that the transistor M6 in the switch 520 in this embodiment is independently controlled by the gate signal GL4. Under such conditions, the conductive or off state of the transistor M6 does not need to be linked to the transistors M1 and M7, but can be independently turned on or off according to the gate signal GL4.

Regarding the control details of the transistor M6, in the test mode, compared to the waveform of FIG. 3B, the gate signal GL4 may have the same waveform as the gate signal GL1 in the stages S1 to S4. That is, the pixel circuit 500 operates similarly to the pixel circuit 300 in stages S1 to S4 in the test mode. In stage S5, the gate signal GL4 may not be pulled up to a logic high voltage, and the transistor M6 may be maintained in an off state. Moreover, in the stage S6, the gate signal GL4 may be pulled up to a logic high voltage different from the gate signal GL1, and the transistor M6 may be maintained in a conductive state. The driving current generated by the driving circuit 510 is transmitted to the external end ETE through the turned-on transistor M6.

In the normal operating mode, in stages S1 to S7, the gate signal GL4 may have the same waveform as the gate signal GL1 in FIG. 4B. The light emitting component LD can be effectively lit.

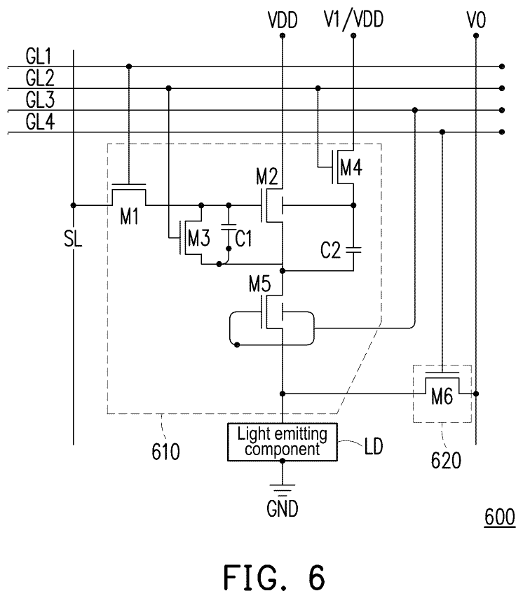

Referring to FIG. 6 below, FIG. 6 is a schematic diagram of a pixel circuit of another embodiment of the disclosure. The pixel circuit 600 includes a driving circuit 610 and a switch 620. In this embodiment, the driving circuit 610 includes transistors M1 to M5 and capacitors C1 and C2. The switch 520 is formed of the transistor M6. The driving circuit 510 is coupled to the light emitting component LD through the driving end DVE.

Different from the embodiment of FIG. 5, the driving circuit 610 of this embodiment removes the transistor M7 and the capacitor C3 of the embodiment of FIG. 5, thereby reducing the circuit components in the pixel circuit 600.

In terms of operation details, based on this embodiment, the transistor M7 has been removed. Therefore, in the test mode, the conduction operation of the transistor M7 in stage 5 in the waveform of FIG. 3B can be skipped and does not need to be executed. In the normal operating mode, the conduction operation of the transistor M7 in stage 5 in the waveform of FIG. 4B does not need to be executed, and stages 4 and 6 can be combined into one identical stage.

In this embodiment, by reducing the circuit components in the pixel circuit 600, the circuit size of the pixel circuit 600 can be reduced. In this way, a relatively large number of pixel circuits 600 can be laid out on the same circuit area, effectively improving the display resolution of the display panel.

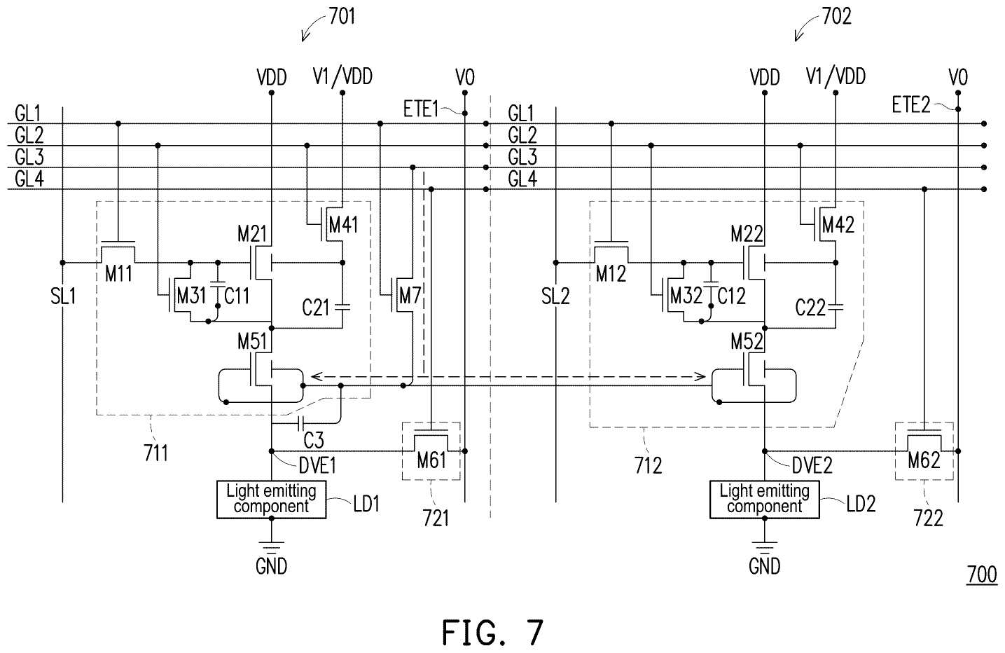

Referring to FIG. 7 below, FIG. 7 is a schematic diagram of a display panel of an embodiment of the disclosure. The display panel 700 includes multiple pixel circuits 701 and 702. The pixel circuits 701 and 702 can be arranged in an array. The pixel circuits 701 and 702 may have the same circuit architecture. The pixel circuit 701 includes a driving circuit 711 and a switch 721. The driving end DVE1 of the driving circuit 711 is coupled to the light emitting component LD1, and the switch 721 is coupled between the driving end DVE1 and the external end ETE1. The pixel circuit 702 includes a driving circuit 712 and a switch 722. The driving end DVE2 of the driving circuit 712 is coupled to the light emitting component LD2, and the switch 722 is coupled between the driving end DVE2 and the external end ETE2. The anode ends of the light emitting components LD1 and LD2 can be respectively coupled to the corresponding driving ends DVE1 and DVE2, and the cathode ends of the light emitting components LD1 and LD2 can be coupled to the reference ground end GND.

The driving circuit 711 includes transistors M11 to M51, M7 and capacitors C11 to C21, and the switch 721 can be formed of the transistor M61. The driving circuit 712 includes transistors M12 to M52, M72 and capacitors C12 to C22, and the switch 722 can be formed of the transistor M62. The driving circuit 711 and the driving circuit 712 are respectively coupled to the source lines SL1 and SL2, and jointly receive the gate signals GL1 to GL4.

The pixel circuits 710 and 702 may have the same circuit architecture as the pixel circuit 510 in the embodiment of FIG. 5, and are not repeated herein.

It is worth mentioning that the number of pixel circuits on the display panel 700 can be set by the designer according to product requirements, and there is no certain limit. The two pixel circuits 701 and 702 shown in FIG. 7 are only examples for illustration and are not intended to limit the scope of the disclosure.

In addition, the pixel circuits 701 and 702 of this embodiment can also be replaced by the pixel circuit 200 of the embodiment of FIG. 2.

The operation details of each pixel circuit 701 and 702 have been described in detail in the foregoing embodiments, and are not repeated herein.

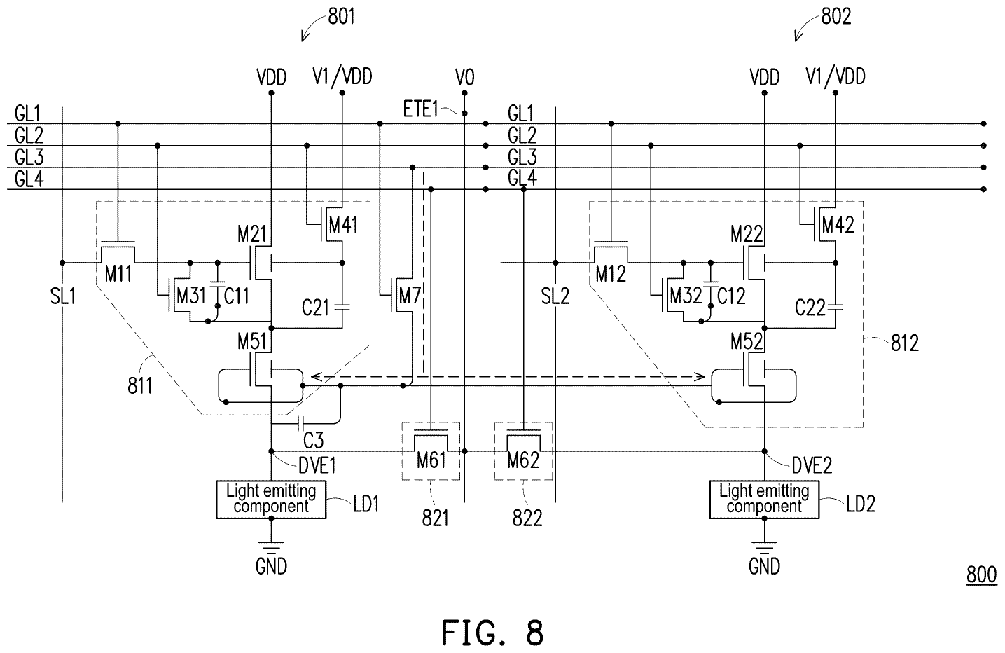

Referring to FIG. 8 below, FIG. 8 is a schematic diagram of a display panel of an embodiment of the disclosure. The display panel 800 includes multiple pixel circuits 801 and 802, a transistor M7 and a capacitor C3. The pixel circuits 801 and 802 can be arranged in an array. The pixel circuits 801 and 802 may have the same circuit architecture. The pixel circuit 801 includes a driving circuit 811 and a switch 821. The driving end DVE1 of the driving circuit 811 is coupled to the light emitting component LD1, and the switch 821 is coupled between the driving end DVE1 and the external end ETE1. The pixel circuit 802 includes a driving circuit 812 and a switch 822. The driving end DVE2 of the driving circuit 812 is coupled to the light emitting component LD2, and the switch 822 is coupled between the driving end DVE2 and the external end ETE2. The anode ends of the light emitting components LD1 and LD2 can be respectively coupled to the corresponding driving ends DVE1 and DVE2, and the cathode ends of the light emitting components LD1 and LD2 can be coupled to the reference ground end GND.

The driving circuit 811 has the same circuit architecture as the driving circuit 610 of the embodiment of FIG. 6. The driving circuit 811 includes transistors M11 to M51 and capacitors C11 and C21, and the switch 821 can be composed of a transistor M61. The driving circuit 812 includes transistors M12 to M52 and capacitors C12 and C22, and the switch 822 can be formed of a transistor M62. The driving circuit 811 and the driving circuit 812 are respectively coupled to the source lines SL1 and SL2, and jointly receive the gate signals GL1 to GL4.

It is worth mentioning that in this embodiment, the transistor M7 and the capacitor C3 can be arranged outside the pixel circuits 801 and 802 and between the pixel circuits 801 and 802. In this arrangement, the transistor M7 and the capacitor C3 can be shared by the pixel circuits 801 and 802. The first end of the transistor M7 receives the gate signal GL4; the control end of the transistor M7 receives the gate signal GL1; the second end of the transistor M7 is coupled to the gate ends and the back gates of the transistors M51 and M52. The capacitor C3 is coupled between the second end of the transistor M7 and the second end of the transistor M51.

In this embodiment, by sharing the transistor M7 and the capacitor C3 among multiple pixel circuits 801 and 802, the circuit size of each pixel circuit 801 and 802 can be reduced. A relatively large number of pixel circuits 801 and 802 can be laid out on the same circuit area, effectively improving the display resolution of the display panel.

Similarly, the number of pixel circuits on the display panel 800 can be set arbitrarily by the designer according to actual requirements. The illustration in FIG. 8 is only an example for illustration and is not intended to limit the scope of the disclosure.

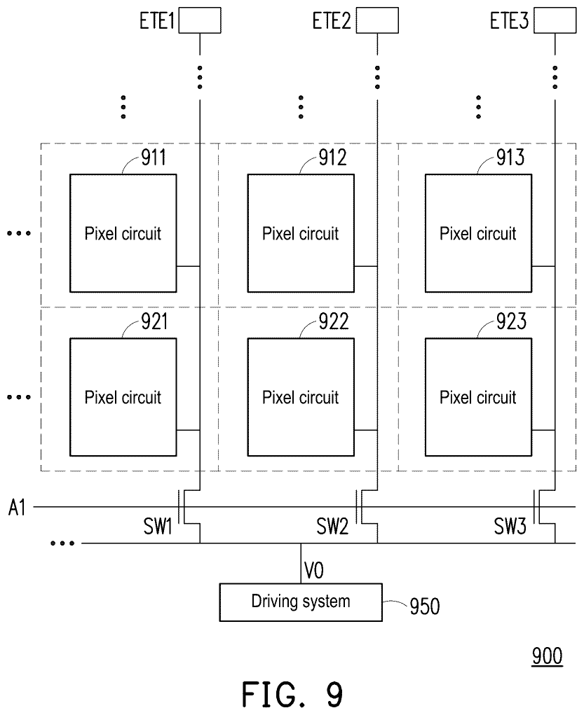

Referring to FIG. 9 below, FIG. 9 is a schematic diagram of a display panel of an embodiment of the disclosure. The display panel 900 has multiple pixel circuits 911 to 923. The pixel circuits 911 to 923 are arranged in an array on the display panel 900. Each pixel circuit 911 to 923 can be constructed by any pixel circuit in the aforementioned embodiments, and the details are not repeated herein.

In this embodiment, the pixel circuits 911 and 921 set in the same column are coupled to the external end ETE1 and coupled to the driving system 950 through the switch SW1; the pixel circuits 912 and 922 are coupled to the external end ETE2 and coupled to the driving system 950 through the switch SW2; the pixel circuits 913 and 923 are coupled to the external end ETE3 and coupled to the driving system 950 through the switch SW3. The switches are controlled by the control signal A1, and when the switches SW1 to SW3 are turned on, the pixel circuits 911 to 933 can receive the setting signal V0 provided by the driving system 950.

In terms of implementation details, when the pixel circuits 911 to 933 are not provided with light emitting components, the switches SW1 to SW3 can be turned off according to the control signal A1. At this time, the pixel circuits 911 to 933 do not receive the setting signal V0, but can send the driving current to the external ends ETE1 to ETE3. In this embodiment, the external ends ETE1 to ETE3 may be test bonding pads. The driving current can be received by an external test circuit and execute test operations of each pixel circuit 911 to 933.

After completing the setting operation of the light emitting components on the pixel circuits 911 to 933, the switches SW1 to SW3 can be turned on according to the control signal A1 and receive the setting signal V0 to execute the corresponding light emitting operation.

In this embodiment, the driving system 950 can be a control circuit set outside the display panel 900 to provide a corresponding setting signal V0 according to the operating state of the display panel 900.

To sum up, the pixel circuit of the disclosure sets a switch between the driving end that provides the driving current and the external end. By activating this switch, it can be used in the test mode, where turning on this switch can transmit the driving current to the external end to execute test operations. It can also be used in the normal operating mode, where turning on this switch can transmit the setting signal to the inside of the driving circuit, so that the light emitting component can be lit normally. Furthermore, embodiments of the disclosure can reduce the size of the pixel circuit and improve the display resolution of the display panel by sharing some circuit components in the driving circuit.

What is claimed is:

1. A pixel circuit, comprising:
a driving circuit, configured to couple to a light emitting component, receive write-in data, and generate a driving current on a driving end according to the write-in data to drive the light emitting component; and
a first switch, coupled between the driving end and an external end, and controlled by a control signal.

2. The pixel circuit according to claim 1, wherein the first switch is configured to transmit a test signal on the driving end to the external end or transmit a setting signal from the external end to the driving end.

3. The pixel circuit according to claim 1, wherein the driving circuit comprises:
a second switch, having a first end to receive the write-in data and controlled by a first gate signal;
a driving transistor, having a first end receiving a power supply voltage, a control end of the driving transistor coupling to a second end of the first switch;
a third switch, coupled between the second end of the driving transistor and the driving end; and
a first capacitor, coupled between the control end of the driving transistor and the second end of the driving transistor.

4. The pixel circuit according to claim 3, wherein the driving circuit further comprises:
a fourth switch, connected between two ends of the first capacitor, controlled by a second gate signal;
a fifth switch, having a first end receiving a reference voltage, a second end of the fifth switch coupling to a back gate of the driving transistor, and controlled by the second gate signal; and
a second capacitor, coupled between the second end of the fifth switch and the second end of the driving transistor.

5. The pixel circuit according to claim 4, wherein the reference voltage is the first gate signal.

6. The pixel circuit according to claim 4, wherein the driving circuit further comprises:
a sixth switch, having a first end receiving a third gate signal, a second end of the sixth switch coupling to a control end of the third switch; and
a third capacitor, coupled between the control end of the third switch and the driving end.

7. The pixel circuit according to claim 4, wherein the control signal is the first gate signal or a fourth gate signal, and the first gate signal is different from the fourth gate signal.

8. The pixel circuit according to claim 1, wherein when coupling between the light emitting component and the driving end is cut off, the first switch is turned on according to the control signal to transmit a test signal on the driving end to the external end, the test signal is the driving current.

9. The pixel circuit according to claim 1, wherein when the light emitting component is coupled to the driving end, the first switch is turned on according to the control signal to transmit a setting signal from the external end to the driving end, and causes the light emitting component to receive the setting signal.

10. A display panel, comprising:
a plurality of pixel circuits, arranged into a display array, each of the pixel circuits comprising:
a driving circuit, configured to couple to a light emitting component, receive write-in data, and generate a driving current on a driving end according to the write-in data to drive the light emitting component; and
a first switch, coupled between an end of the light emitting component receiving the driving current and an external end, and controlled by a control signal.

11. The display panel according to claim 10, wherein each of the first switches is configured to transmit a test signal on each of the driving ends to each of the external ends or transmit a setting signal from each of the external ends to each of the driving ends.

12. The display panel according to claim 10, wherein each of the driving circuits comprises:
a second switch, having a first end to receive the write-in data and controlled by a first gate signal;
a driving transistor, having a first end receiving a power supply voltage, a control end of the driving transistor coupling to a second end of the first switch;
a third switch, coupled between the second end of the driving transistor and the driving end; and
a first capacitor, coupled between the control end of the driving transistor and the second end of the driving transistor.

13. The display panel according to claim 12, wherein each of the driving circuit further comprises:
a fourth switch, connected between two ends of the first capacitor, controlled by a second gate signal;
a fifth switch, having a first end receiving a reference voltage, a second end of the fifth switch coupling to a back gate of the driving transistor, and controlled by the second gate signal; and
a second capacitor, coupled between the second end of the fifth switch and the second end of the driving transistor.

14. The display panel according to claim 13, further comprising:
a sixth switch, having a first end receiving a third gate signal, a second end of the sixth switch coupling to control ends of a plurality of the third switches in the driving circuits; and
a third capacitor, coupled between the corresponding control ends of the third switches and the corresponding driving ends.

15. The display panel according to claim 13, wherein each of the control signals is the first gate signal or a fourth gate signal, and the first gate signal is different from the fourth gate signal.

16. The display panel according to claim 10, wherein when coupling between each of the light emitting components and each of the driving ends is cut off, each of the first switches is turned on according to each of the control signals to transmit a test signal on each of the driving ends to each of the external ends, the test signal is the driving current.

17. The display panel according to claim 10, wherein when each of the light emitting components is coupled to the driving end, each of the first switches is turned on according to the control signal to transmit a setting signal from each of the external ends to each of the driving ends, and causes each of the light emitting components to receive the setting signal.

18. The display panel according to claim 10, wherein the pixel circuits are respectively coupled to a driving system through a plurality of second switches, the driving system is configured to provide a setting signal.
